(19) United States
(12) Patent Application Publication
(10) Pub. No.: US 2022/0271368 A1
(43) Pub. Date: Aug. 25, 2022

(54) DEVICE FOR COOLING ONE OR MORE ELECTRICAL POWER STORAGE MODULES

(71) Applicant: Valeo Systemes Thermiques, Le Mesnil Saint-Denis (FR)

(72) Inventors: Fethy Djallal, La Suze Sur Sarthe (FR); Thibaut Perrin, La Suze Sur Sarthe (FR); Marc Herry, La Suze Sur Sarthe (FR); Mohamed Ibrahimi, La Suze Sur Sarthe (FR)

(73) Assignee: Valeo Systemes Thermiques, Le Mesnil Saint-Denis (FR)

(21) Appl. No.: 17/623,070

(22) PCT Filed: Jun. 16, 2020
(86) PCT No.: PCT/FR2020/051039

§ 371 Date: Dec. 27, 2021

(30) Foreign Application Priority Data
Jun. 28, 2019 (FR) FR1907191

(51) Int. Cl. H01M 10/6568; H01M 10/613; H01M 10/6554; H01M 10/6556

(52) U.S. Cl. CPC H01M 10/6568; H01M 10/613; H01M 10/6554; H01M 10/6556; H01M 10/625

(57) ABSTRACT

The invention concerns a cooling device and a battery pack comprising a heat exchanger (10), comprising a first plate (1) forming a so-called bottom face of the exchanger and a second plate (2) forming a second so-called top face of the exchanger, the first and second plates comprising, between them, coolant circulation channels (3) formed in a thickness of the exchanger between the first plate and the second plate, in which the first plate comprises at least one tubular socket (4), for receiving a fluid collection end-piece (5), extending from an outer face of the first plate towards the inside of the exchanger, the second plate comprising at least one boss (6) on the top face of the exchanger and producing a recess (7) that locally increases the thickness of the exchanger on the inner face of the second plate, the recess accommodating the socket and forming a fluid passage between one end (4a) of the socket in the recess and at least one channel (3) of the exchanger.

The present invention relates to a device for cooling one or more electrical energy storage modules and in particular a cooling device comprising a heat exchanger having plates that define an internal space through which a coolant passes.

### TECHNICAL FIELD

In the automotive field, it is known practice to use electric batteries in the form of electrical energy storage modules. Each module may have a plurality of electrical energy storage cells received in a casing. High-density energy storage cells such as Li-ion or Li-polymer batteries ideally need to operate in a temperature range of between 20° C. and 40° C., and a temperature that is too low has an impact on their range while a temperature that is too high has an impact on their service life.

It is known practice to regulate the temperature of electric storage modules, known as battery modules below, by means of plate heat exchangers which are in contact with the modules and in which channels for circulation of a coolant are provided.

### PRIOR ART

Examples of plate exchangers that are usable for cooling battery modules are described in the document DE10 2017 202 552 A1. These exchangers have male liquid-inlet/outlet end fittings for connecting them to an external circuit. These end fittings are generally connected to coolant supply and return pipes.

### SUMMARY

To increase the compactness of electric battery systems of hybrid or electric vehicles and make them easier to design, the battery modules are disposed in casings that generally group together a plurality of modules.

In this case, the plate exchangers may in particular be disposed between a bottom of the casing and the module(s) that it holds and the exchangers may be connected under the exchanger by means of end fittings protruding from the exchangers.

In order to reduce the bulk of these systems, in particular along a vertical axis with respect to the vehicle, the space taken up by the connection devices of the plate exchangers under the exchangers and the thickness of the supply circuits of these exchangers should be reduced.

To this end, the present invention proposes a heat exchanger having a first plate forming a face known as the lower face of the exchanger and a second plate forming a second face known as the upper face of the exchanger, the first and second plates having, between one another, coolant circulation channels formed in a thickness of the exchanger between the first plate and the second plate, wherein the first plate has at least one tubular mount, for receiving an end fitting for fluidic connection, extending from an external face of the first plate toward the interior of the exchanger, the second plate having at least one boss on the upper face of the exchanger producing a cavity that locally increases the thickness of the exchanger on the internal face of the second plate, said cavity accommodating said mount and constituting a fluidic passage between an end of said mount in the cavity and at least one channel of the exchanger.

In this way, the exchanger does not have visible fragile connection end fittings and is more compact.

According to one embodiment, the exchanger has a first boss accommodating a first tubular mount for the inlet of liquid for supplying the channels of the exchanger and a second boss accommodating a second tubular mount for the outlet of liquid from the channels of the exchanger.

The bosses accommodating said mounts are preferably disposed at the boundary of the upper plate of the exchanger away from a contact surface of said upper plate with a heat exchange surface of an electrical energy storage module to be cooled.

An end of the tubular mount on the inner side of the exchanger may have a narrowed inside diameter for retaining an O-ring.

The O-ring may also be accommodated in a groove in the end fitting or in a groove in the mount.

The application also relates to a device which has at least one heat exchanger according to one of the embodiments as described above and a coolant supply and return device provided with tubular fluidic connection end fittings designed to fit in the tubular mounts.

The liquid supply and return device is preferably made up of ducts integrated in the thickness of a wall of a casing for receiving one or more modules, the end fittings in fluidic communication with the ducts extending from said wall.

This device thus makes it possible to minimize the height of the casing/plate exchanger assembly under the modules.

The wall and the exchanger may have means for guiding the exchanger into position while it is being inserted into the casing in order to align the end fittings and the mounts during the coupling thereof.

The application also relates to a battery pack having at least one cooling device as described with a casing and at least one electrical energy storage module received in the casing and placed on said exchanger, which itself is disposed on a compressible foam placed on said wall of the casing, and wherein the coolant supply and return end fittings extending from said wall protrude beyond the thickness of the foam and are fitted in the mounts of the exchanger.

In this configuration, the electrical energy storage module is easily applied to the exchanger by compressing the foam and the fluidic connection does not take up space in terms of height under the module.

The wall is preferably a bottom wall of the casing, said casing having said bottom wall, a peripheral wall and a removable cover.

The electrical energy storage module(s) or subassemblies comprising them may be provided with fastening plates or fins, receiving rods for fastening the electrical energy storage module(s) in the casing that are vertically above said bosses.

### BRIEF DESCRIPTION OF THE DRAWINGS

Further features, details and advantages will become apparent on reading the following detailed description, and on studying the appended drawings, in which:

FIG. 1A shows a perspective top view of an exchanger;

FIG. 1B shows a perspective bottom view of the exchanger in FIG. 1A with a cutaway;

FIG. 2 shows a cross-sectional view of a detail of the connection of an exchanger to a liquid supply duct;

FIG. 3 shows a cross-sectional perspective view of a part for assembling an exchanger and an energy storage module on a casing wall;

FIG. 4 shows an exploded cross-sectional perspective view of a battery pack grouping together a plurality of exchangers and a plurality of energy storage modules according to the application.

### DESCRIPTION OF THE EMBODIMENTS

The drawings and the description below contain, for the most part, elements of a certain character. Therefore, they may not only serve for understanding the present disclosure better, but also contribute to its definition, where appropriate.

The present application relates to a system for cooling energy storage modules.

The name electrical energy storage module is given to a module having one or more individual electric storage cells, this module being able to be part of a subassembly having a fastening frame, cables and control electronics.

In the context of the present invention, one or more modules are combined with a cooling device to create a battery pack that is usable in an electric vehicle for example.

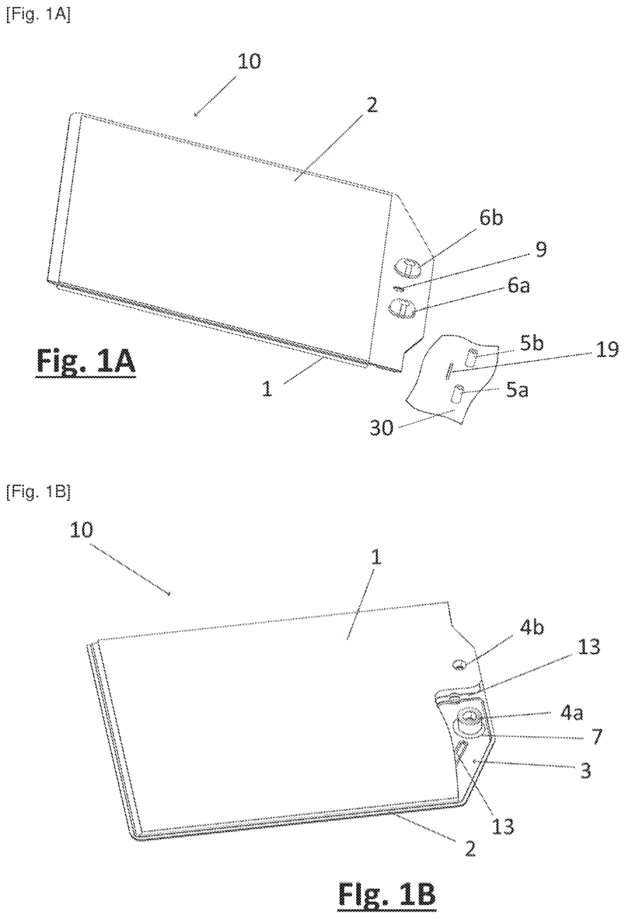

The cooling device has a plate exchanger 10 as described in FIGS. 1A and 1B, in which channels 3 are formed for a coolant to flow through.

The exchanger 10 has a first plate 1, referred to here by convention as upper plate, which is generally flat and on which an electrical energy storage module will be placed in order for it to be possible to control the temperature of the latter. Bosses 6a, 6b are formed on the plate 1.

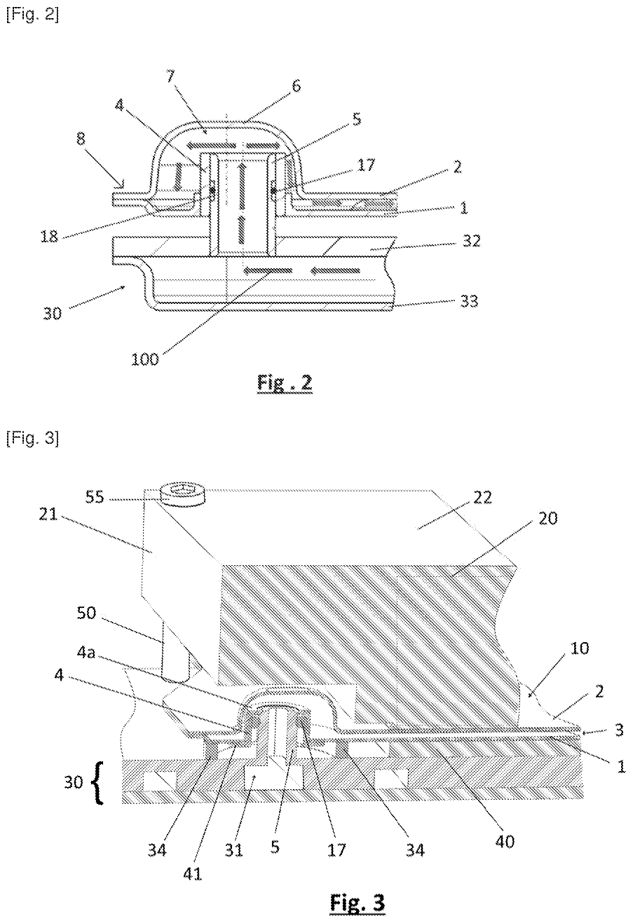

The exchanger has a second plate 2, referred to here by convention as lower plate. According to FIG. 1B, the lower plate 2 has pressed ribs 13 which are welded to the lower face of the upper plate and which define the channels 3 and have tubular mounts 4a, 4b in communication with the channels 3, and one end of which is flush with the external face of the plate 2 while their other end, inside the exchanger, is situated in a cavity under the boss. The cutaway in FIG. 2 reveals the mount 4b, the end of which inside the exchanger is located in the cavity under the boss 6b in FIG. 1, and the mount 4a, an inlet face of which is located on the external face of the lower face 1 of the exchanger. The bosses and mounts are situated on one end of the exchanger in order to free up a large area for receiving the energy storage module.

The exchanger is connected to a liquid supply and return device which has end fittings that are inserted into the tubular mounts, as shown in FIG. 2.

According to this figure, the exchanger 10 is shown in cross section at the boss 6 of a liquid supply circuit. The end fitting 5 is in communication with a duct 31 in a wall 30 or a pipe under the exchanger.

The liquid circuit 100 starts from the duct 31, ascends in the end fitting 5 inserted into the mount 4, emerges into the cavity 7 under the boss 6, descends back along the outer walls of the mount 4 in order to be directed into the channel 3 between the plates 1 and 2.

An O-ring 17 disposed in a groove 18 in the mount or the end fitting provides the seal between the mount and the end fitting.

In a traditional manner, the edges 8 of the plates enclose the exchanger and are welded together.

At a liquid outlet mount, the liquid circuit is reversed to pass back into a return duct in the wall 30 or an outlet pipe.

In order to position the exchanger on the wall 30, the exchanger and the wall have complementary guide means. According to FIG. 1A, these means may be realized with the aid of a finger 19 which is fastened to the wall and is inserted into a hole 9 made in the exchanger close to the bosses. Optionally, a second, identical device on the other side of the plate may be provided in order to align the exchanger angularly with respect to the wall. The guide means may also be realized by means of ribs inside a peripheral wall of a casing receiving the exchanger.

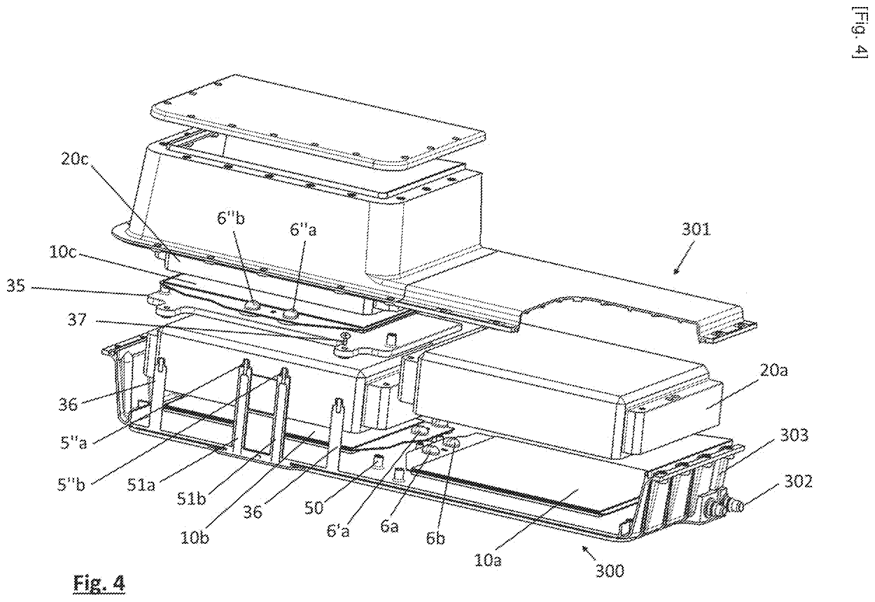

FIG. 3 shows a cross section through one end of an electrical energy storage module 20 or a subassembly comprising such a module on an exchanger 10, itself connected to an end fitting 5 extending from a wall 30 provided with a duct 31. In this configuration, the electrical energy storage module 20 is mounted in a cradle 22 that carries the cables and the control electronics of the module and is schematically indicated by its bulk. The cradle may in this case have the fins 21 or the plates for fastening the module to the lower wall 30 by means of rods 50 that receive screws 55 passing through holes made in the fins or plates.

The wall 30 is in this case made in two longitudinal plastic or composite parts in which the ducts 31 are provided.

The fins 21 are located above the bosses 6, thereby reducing the space lost for the fluidic connections of the exchanger.

The channels 3 between the upper plate 2 of the exchanger 10 and the lower plate 1 are situated under the bottom of the electrical energy storage module or the bottom of the subassembly comprising it, the upper plate 2 making contact with this bottom.

The exchanger 10 is placed on a sheet of foam 40 which, compressed during the fastening of the module, keeps the exchanger in contact with the module to ensure optimal heat transfer.

The end fittings 5 of the wall 30, which are in communication with ducts 31 in this wall, are fitted into the mounts 4. An O-ring 17, held by a rim 4a formed by a reduced-diameter upper zone of the mount, provides sealing between the end fitting and the mount. The rim may also serve as a stop for the insertion of the end fitting into the mount.

According to this example, the mounts have a flange 41 welded to the lower plate 1. Under the lower plate, around the junction between the end fittings and the mounts, there is disposed a compressible additional O-ring seal 34.

FIG. 4 shows a battery pack having three energy storage modules 20a, 20b, 20c, two first modules 20a, 20b being disposed in the bottom of a casing 300 and a third module 20c being disposed above one of the two first modules.

The casing has a bottom 30 constituting a wall provided with liquid supply and return ducts which are connected to an external circuit by means of fluidic connectors 302. The casing also has a peripheral wall 303 and a cover 301 which closes the casing.

The first modules 20a, 20b are fastened to the bottom wall by means of spacers 50 and are each positioned on an exchanger 10a, 10b fitted on connecting mounts, the mounts 5′a, 5′b being visible in the drawing. The geometry of the exchangers at the location at which their bosses 6a, 6b, 6′a, 6′b are positioned is determined to allow the exchangers to be connected to separate or identical ducts depending on the desired configuration.

The third module 20c, disposed above one of the modules 20a, 20b, is fastened to a support plate 35, itself fastened to the bottom wall by means of columns 36, which extend from the bottom wall or are attached to the latter, and screws 37 according to the example shown. The support plate 35 receives an exchanger 10c, the mounts of which under the bosses 6″a, 6″b receive end fittings 5″a, 5″b mounted in the continuation of tubular columns 51a, 51b which extend from the bottom of the housing and which are in communication with supply and return ducts in the bottom wall of the casing like as is the case for the other end fittings.

In this case, the mounts are disposed on a lateral side of the exchanger and not at one of its longitudinal ends.

The device of the invention, which is not limited to the examples shown, and in which the number of energy storage modules may be variable and different than one or three, thus allows numerous arrangements for the supply and return of the cooling liquid to/from the exchangers, a high level of compactness of the battery packs, which may have several stages, and the production of compact battery packs without external or internal pipes, this being particularly favorable in terms of weight and ease of assembly.

1. A heat exchanger comprising:
a first plate forming a face known as the lower face of the exchanger; and
a second plate forming a second face known as the upper face of the exchanger,
the first and second plates having, between one another, coolant circulation channels formed in a thickness of the exchanger between the first plate and the second plate,
wherein the first plate has at least one tubular mount, for receiving an end fitting for fluidic connection, extending from an external face of the first plate toward the interior of the exchanger, the second plate having at least one boss on the upper face of the exchanger and producing a cavity that locally increases the thickness of the exchanger on the internal face of the second plate,
said cavity accommodating said mount and constituting a fluidic passage between an end of said mount in the cavity and at least one channel of the exchanger.

2. The heat exchanger as claimed in claim 1, having a first boss accommodating a first tubular mount for the inlet of liquid for supplying the channels of the exchanger and a second boss accommodating a second tubular mount for the outlet of liquid from the channels of the exchanger.

3. The heat exchanger as claimed in claim 2, wherein said bosses accommodating said mounts are disposed at the boundary of the upper plate of the exchanger away from a contact surface of said upper plate with a heat exchange surface of an electrical energy storage module to be cooled.

4. The heat exchanger as claimed in claim 1, wherein the end of the tubular mount on the inner side of the exchanger has a narrowed inside diameter for retaining an O-ring.

5. A device for cooling one or more electrical energy storage modules comprising at least one heat exchanger as claimed in claim 1; and a coolant supply and return device provided with tubular fluidic connection end fittings configured to fit in the tubular mounts.

6. The cooling device as claimed in claim 5, wherein the liquid supply and return device is made up of ducts integrated in the thickness of a wall of a casing for receiving one or more of said modules, the end fittings in fluidic communication with the ducts extending from said wall.

7. The cooling device as claimed in claim 6, wherein the wall and the exchanger have means for guiding the exchanger into position while it is being inserted into the casing in order to align the end fittings and the mounts during the coupling thereof.

8. A battery pack comprising: at least one cooling device as claimed in claim 6; and at least one electrical energy storage module received in the casing and placed on said exchanger, which itself is disposed on a compressible foam placed on said wall of the casing, and wherein the coolant supply and return end fittings extending from said wall protrude beyond the thickness of the foam and are fitted in the mounts of the exchanger.

9. The battery pack as claimed in claim 8, wherein said wall is a bottom wall of the casing, said casing having said bottom wall, a peripheral wall and a removable cover.

10. The battery pack as claimed in claim 8, wherein the electrical energy storage module(s) or subassemblies comprising them are provided with fastening plates or fins, receiving rods for fastening the electrical energy storage module(s) in the casing that are vertically above said bosses.
